(19) United States
(12) Patent Application Publication
(10) Pub. No.: US 2012/0256343 A1
(43) Pub. Date: Oct. 11, 2012

(54) PROCESS FOR INJECTION MOLDING OF HOLLOW PRODUCT HAVING IRREGULAR SHAPE WITH PLASTIC MATERIAL INSTEAD OF METAL MATERIAL

(76) Inventor: Mingcong Tao, Shenshen City (CN)

(21) Appl. No.: 13/345,421

(22) Filed: Jan. 6, 2012

(30) Foreign Application Priority Data
Apr. 7, 2011 (CN) 201110090102.3

(51) Int. Cl. B29C 45/14

(52) U.S. Cl. 264/251; 425/129.1

(57) ABSTRACT

The disclosure relates to a process of injection molding of hollow product with plastic material includes steps of (1) molding upper and lower half parts with a same mold including first and second mold halves, a convex-concave structure is respectively disposed in matching surfaces of the upper and lower half parts, two grooves are respectively defined in two opposite outer sides of the combination of the upper and lower half parts; (2) opening the mold, the upper half part is left with the first mold half, the lower half part is left with the second mold half; (3) moving the second mold half or rotating the second mold half 180 degrees to make the lower half part align with the upper half part; (4) injecting plastic material into the grooves to form two connecting strips; (5) having the mold cooled, opening the mold and having the hollow product pushed out.

### CROSS-REFERENCE OF THE RELATED APPLICATIONS

This application claims the benefit of Chinese Patent Application No. 201110090102.3, filed Apr. 7, 2011, which is incorporated entirely by reference herein.

### FIELD OF THE INVENTION

The present disclosure relates to a process for injection molding, and, more particularly, to a process for injection molding of hollow product having an irregular shape with plastic material instead of metal material.

### BACKGROUND OF THE INVENTION

Currently, many kinds of hollow products with regular shapes, such as, linear, arc, and so on, are manufactured by injection molding of plastic material. Due to the regular shapes, core pulling can be finished smoothly. However, for the hollow products with irregular shapes, for example, spline curved, it is difficult to finish the core pulling during injection molding of plastic material. In order to manufacture the hollow plastic products with irregular shapes, casting with copper or other metal material instead of plastic is applied for that. But casting is a high pollution and a high emission of process.

What is needed, therefore, is a process for injection molding of hollow product having an irregular shape with plastic material instead of metal material.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a perspective view of a hollow product with an irregular shape in accordance with a first embodiment of the disclosure.

FIG. 2 is a cross sectional view of the hollow product of FIG. 1.

FIG. 3 shows a schematic diagram of an upper half part and a lower half part of a hollow product in accordance with a first embodiment of the disclosure.

FIG. 4 is a cross sectional view of the hollow product of FIG. 3.

FIG. 5 is a perspective view of an upper half part of the hollow product of FIG. 3.

FIG. 6 is a perspective view of a lower half part of the hollow product of FIG. 3.

FIG. 7 is a perspective view of two connecting strips connecting the upper half part and the lower half part of the hollow product of FIG. 3.

FIG. 8 is a structural view of a mold in accordance with a first embodiment of the disclosure, wherein the mold includes a first mold half and a second mold half, and the mold forms two upper half parts and two lower half parts.

FIG. 9 is a schematic diagram of moving the second mold half to make the upper half parts align with the lower half parts of FIG. 8.

FIG. 10 is an additional structural view of a mold of FIG. 8.

FIG. 11 is a schematic diagram of rotating the second mold half 180 degrees to make the upper half parts align with the lower half parts of FIG. 10.

FIG. 12 is a perspective view of a hollow product with an H shape in accordance with a second embodiment of the disclosure.

FIG. 13 is a cross sectional view of the hollow product of FIG. 12.

FIG. 14 shows a schematic diagram of an upper half part and a lower half part of a hollow product in accordance with a second embodiment of the disclosure.

FIG. 15 is a perspective view of an upper half part of the hollow product of FIG. 14.

FIG. 16 is a perspective view of a lower half part of the hollow product of FIG. 14.

FIG. 17 is a perspective view of two connecting strips connecting the upper half part and the lower half part of the hollow product of FIG. 14.

FIG. 18 is a cross sectional view of the hollow product of FIG. 14, taken along line A-A.

FIG. 19 is a structural view of a mold in accordance with a second embodiment of the disclosure, wherein the mold includes a first mold half and a second mold half, and the mold forms two upper half parts and two lower half parts.

FIG. 20 is a schematic diagram of moving the second mold half to make the upper half parts align with the lower half parts of FIG. 19.

FIG. 21 is an additional structural view of a mold of FIG. 19.

FIG. 22 is a schematic diagram of rotating the second mold half 180 degrees to make the upper half parts align with the lower half parts of FIG. 21.

FIG. 23 is a structural view of a mold in accordance with an embodiment of the disclosure.

### DETAILED DESCRIPTION OF THE INVENTION

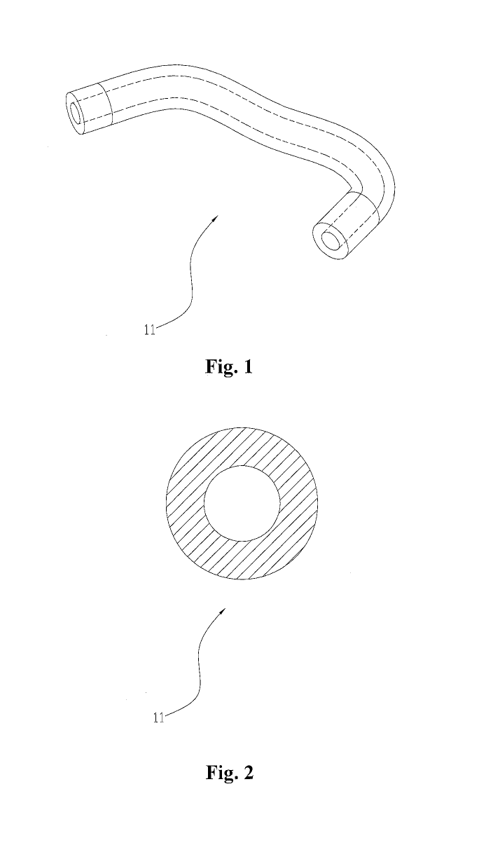

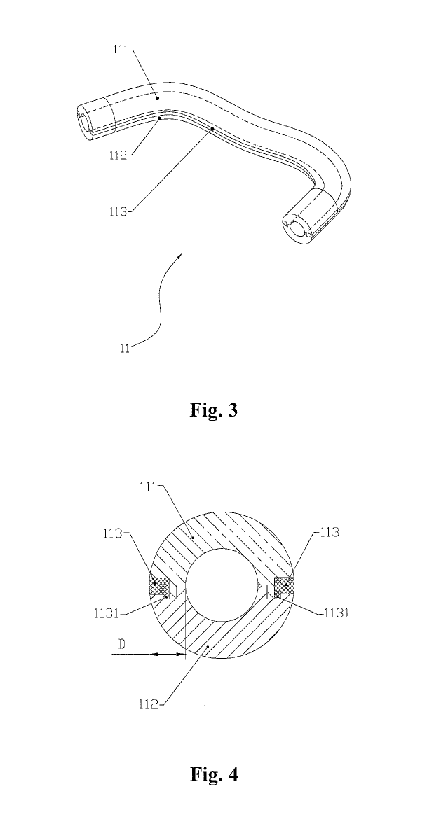

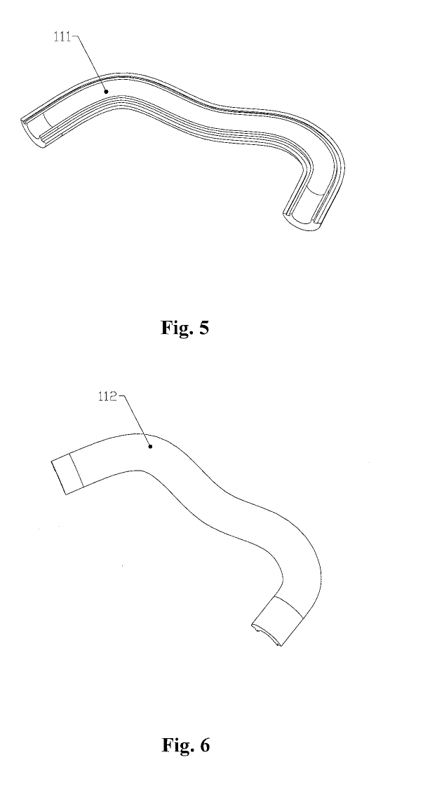

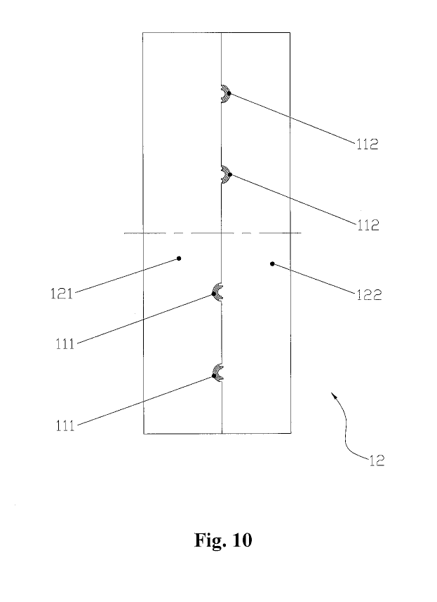

Referring to FIGS. 1-11, a process of injection molding of a hollow product 11 having an irregular shape with plastic material instead of metal material in accordance with a first embodiment of the disclosure is illustrated. In this embodiment, the hollow product 11 has a curved configuration (viewed from FIG. 1). The process of injection molding includes steps of:

(1) molding an upper half part 111 of the hollow product 11 and a lower half part 112 of the hollow product 11 with a same mold 12. The mold 12 includes a first mold half 121 and a second mold half 122. A convex structure and a concave structure are respectively disposed in matching surfaces of the upper half part 111 and the lower half part 112. The upper half part 111 and the lower half part 112 are combined with each other via the convex structure and the concave structure. Two grooves are respectively defined in two opposite outer sides of the combination of the upper half part 111 with the lower half part 112.

(2) opening the mold 12, after the mold 12 is opened, the upper half part 111 is left with the first mold half 121, the lower half part 112 is left with the second mold half 122.

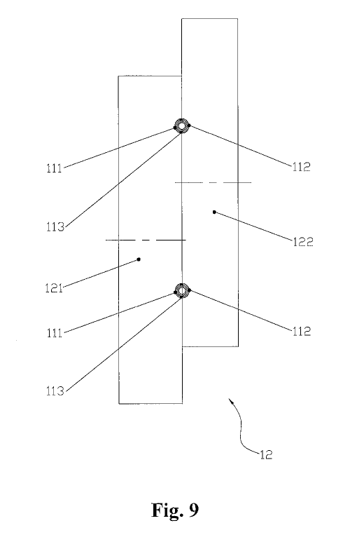

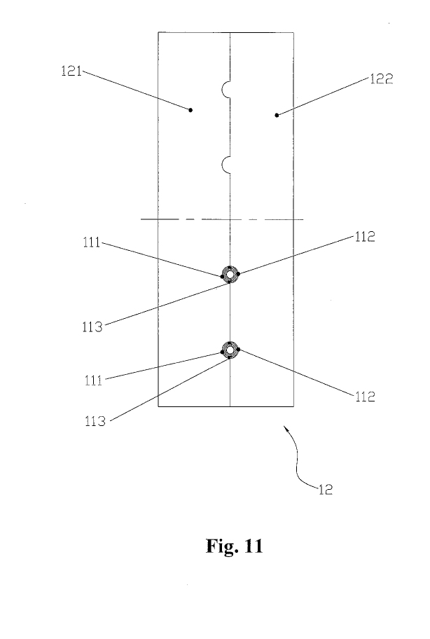

(3) moving the second mold half 122 to make the lower half part 112 on the second mold half 122 align with the upper half part 111 on the first mold half 121 (viewed from FIG. 9) or rotating the second mold half 122 180 degrees to make the lower half part 112 on the second mold half 122 align with the upper half part 111 on the first mold half 121 (viewed from FIG. 11).

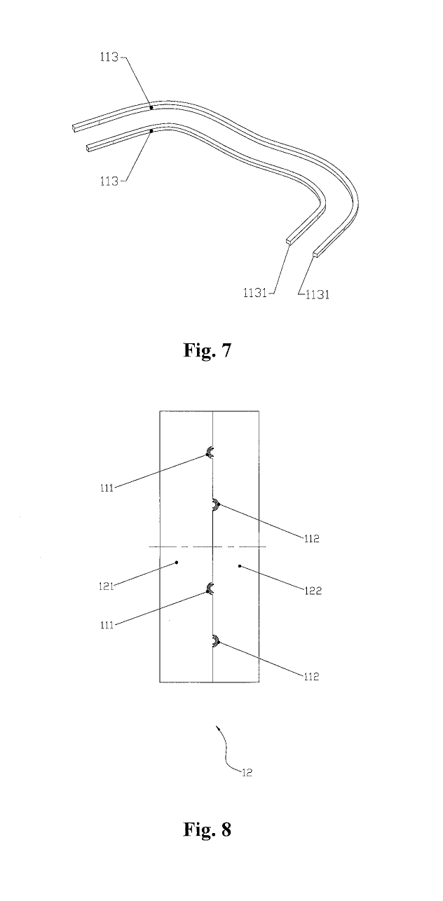

(4) injecting plastic material into the grooves which are respectively defined in two opposite outer sides of the combination of the upper half part 111 with the lower half part 112, thereby forming two connecting strips 113 therein to connect the upper half part 111 with the lower half part 112 (viewed from FIG. 7).

(5) having the mold 12 cooled, opening the mold 12 and having the hollow product 11 pushed out, whereby the hollow product 11 is obtained.

As shown from FIG. 4, in this embodiment, a total thickness D of the upper half part 111, the lower half part 112 and a corresponding connecting strip 113 in combination of the upper half part 111 with the lower half part 112 from inside to outside the hollow product 11 is 2-6 mm. In actual production, if the total thickness D of the upper half part 111, the lower half part 112 and the connecting strip 113 is less than 2 mm, the hollow product 11 can not be manufactured. If the total thickness D of the upper half part 111, the lower half part 112 and the connecting strip 113 is more than 6 mm, the hollow product 11 has a higher cost of production than casting.

As shown from FIG. 4 and FIG. 7, in this embodiment, each of the connecting strips 113 is a strip which has a lathing structure 1131. After injecting plastic material into the grooves which are respectively defined in two opposite outer sides of the combination of the upper half part 111 with the lower half part 112, the connecting strips 113 are firmly latched in the grooves via the latching structure 1131, thereby the upper half part 111 and the lower half part 112 are firmly connected with each other.

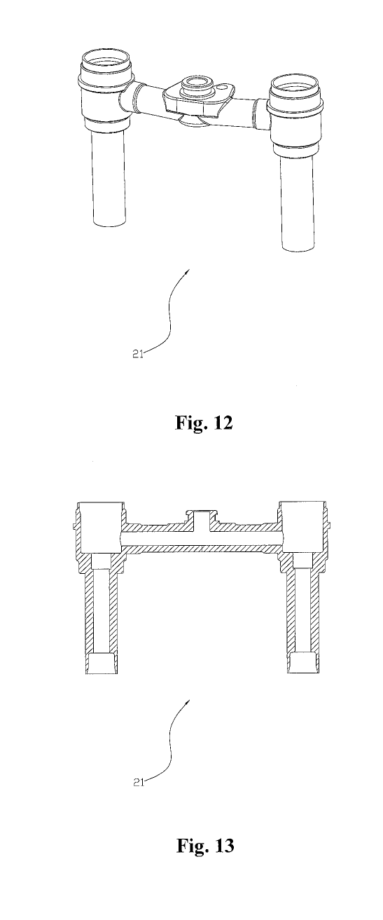

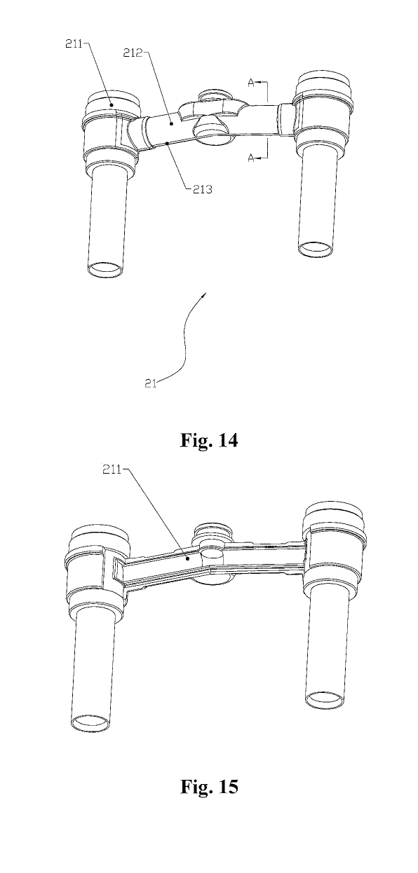

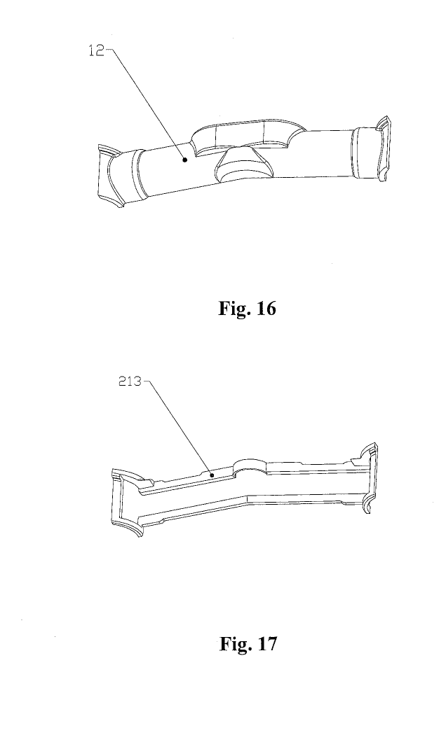

Referring to FIGS. 12-23, a process of injection molding of a hollow product 21 having an irregular shape with plastic material instead of metal material in accordance with a second embodiment of the disclosure is illustrated. In this embodiment, the hollow product 21 has an H configuration (viewed from FIGS. 12-15). The process of injection molding includes steps of:

(1) molding an upper half part 211 of the hollow product 21 and a lower half part 212 of the hollow product 21 with a same mold 22. The mold 22 includes a first mold half 221 and a second mold half 222. A convex structure and a concave structure are respectively disposed in matching surfaces of the upper half part 211 and the lower half part 212. The upper half part 211 and the lower half part 212 are combined with each other via the convex structure and the concave structure. Two grooves are respectively defined in two opposite outer sides of the combination of the upper half part 211 with the lower half part 212.

(2) opening the mold 22, after the mold 22 is opened, the upper half part 211 is left with the first mold half 221, the lower half part 212 is left with the second mold half 222.

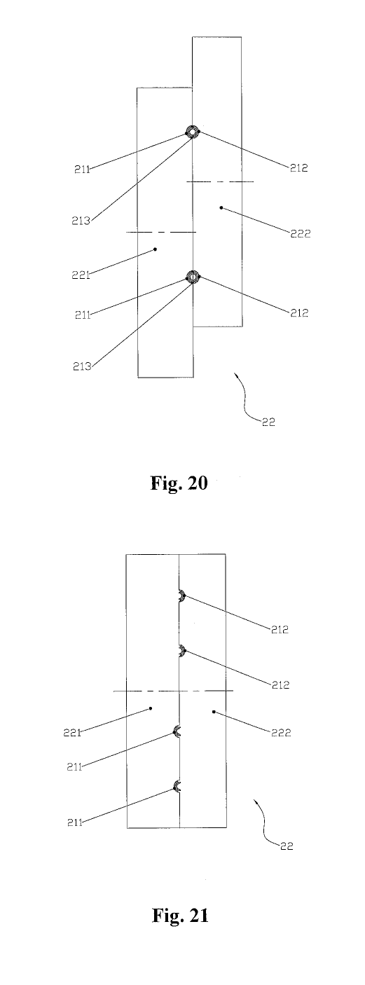

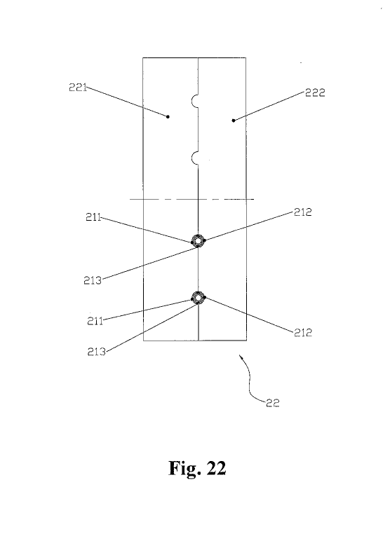

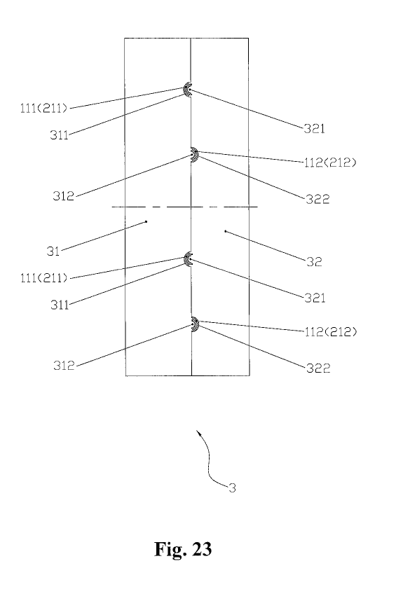

(3) moving the second mold half 222 to make the lower half part 212 on the second mold half 222 align with the upper half part 211 on the first mold half 221 (viewed from FIG. 20) or rotating the second mold half 222 180 degrees to make the lower half part 212 on the second mold half 222 align with the upper half part 211 on the first mold half 221 (viewed from FIG. 22).

(4) injecting plastic material into the grooves which are respectively defined in two opposite outer sides of the combination of the upper half part 211 with the lower half part 212, thereby forming two connecting strips 213 therein to connect the upper half part 211 with the lower half part 212 (viewed from FIG. 17).

(5) having the mold 22 cooled, opening the mold 22 and having the hollow product 21 pushed out, whereby the hollow product 21 is obtained.

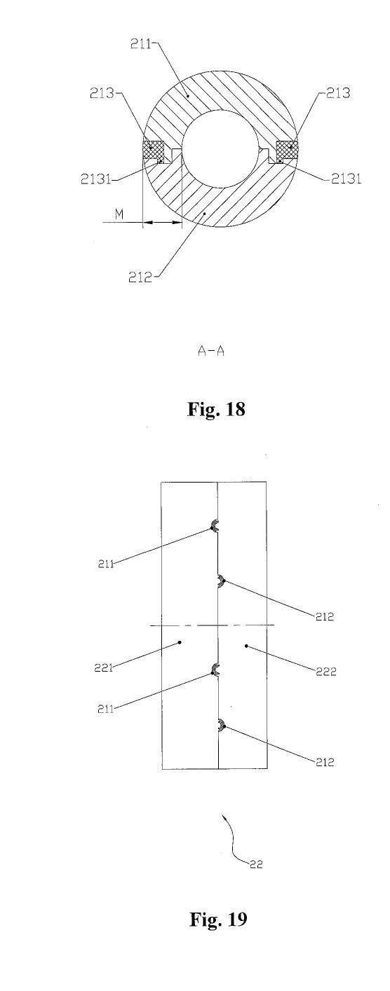

As shown from FIG. 18, in this embodiment, a total thickness M of the upper half part 211, the lower half part 212 and a corresponding connecting strip 213 in combination of the upper half part 211 with the lower half part 212 from inside to outside the hollow product 21 is 2-6 mm. In actual production, if the total thickness M of the upper half part 211, the lower half part 212 and the connecting strip 213 is less than 2 mm, the hollow product 21 can not be manufactured. If the total thickness M of the upper half part 211, the lower half part 212 and the connecting strip 213 is more than 6 mm, the hollow product 21 has a higher cost of production than casting.

As shown from FIG. 17 and FIG. 18, in this embodiment, each of the connecting strips 213 is a strip which has a lathing structure 2131. After injecting plastic material into the grooves which are respectively defined in two opposite outer sides of the combination of the upper half part 211 with the lower half part 212, the connecting strips 213 are firmly latched in the grooves via the latching structure 2131, thereby the upper half part 211 and the lower half part 212 are firmly connected with each other.

Referring to FIG. 23, a mold 3 is used for the process of the injection molding of the first and second embodiments. The mold 3 includes a first mold half 31 and a second mold half 32.

Two first mold cavities 311 are defined in the first mold half 31. Two second mold cores 312 are formed on the first mold half 31. The first mold cavities 311 alternate with the second mold cores 312. Two first mold cores 321 are formed on the second mold half 32. Two second mold cavities 322 are defined in the second mold half 32. The first mold cores 321 alternate with the second mold cavities 322. The first mold cavities 311 of the first mold half 31 are combined with the first mold cores 321 of the second mold half 32 to define a first chamber therebetween supplied for the upper half part 111 of the first embodiment or the upper half part 211 of the second embodiment. The second mold cavities 312 of the first mold half 31 are combined with the first mold cores 321 of the second mold half 32 to define a second chamber therebetween supplied for the lower half part 112 of the first embodiment or the lower half part 212 of the second embodiment.

The upper half part 111 and the lower half part 112 of the first embodiment are formed with the same mold 3, or the upper half part 211 and the lower half part 212 of the second embodiment are formed with the same mold 3, and then the lower half part 112(212) aligns with the upper half part 111(211) after moving the second mold half 32, and then the connecting strips 113(213) are formed at two opposite outer sides of the combination of the upper half part 111(211) with the lower half part 112(212) via injection molding. The connecting strips 113(213) firmly connect the lower half part 112(212) and the upper half part 111(211). Therefore, the hollow product 11(21) is obtained, after cooling, opening and pushing out the hollow product 11(21).

Due to the mold 3, it is easy to manufacture the hollow product 11(21), the upper half part 111(211) is firmly connected with the lower half part 112(212). The hollow product 11(21) has a high quality and a high molding efficiency to overcome the problem of forming a hollow product with an irregular shape via core pulling.

Finally, the above-discussion is intended to be merely illustrative of the disclosure and should not be construed as limiting the appended claims to any particular embodiment or group of embodiments. Thus, while the disclosure has been described with reference to exemplary embodiments, it should also be appreciated that numerous modifications and alternative embodiments may be devised by those having ordinary skill in the art without departing from the broader and intended spirit and scope of the disclosure as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

What is claimed is:

1. A process of injection molding of a hollow product having an irregular shape with plastic material instead of metal material, comprising steps of:
molding an upper half part of the hollow product and a lower half part of the hollow product with a same mold, the mold comprising a first mold half and a second mold half, a convex structure and a concave structure being respectively disposed in matching surfaces of the upper half part and the lower half part, the upper half part and the lower half part being combined with each other via the convex structure and the concave structure, two grooves being respectively defined in two opposite outer sides of the combination of the upper half part with the lower half part;
opening the mold, after the mold is opened, the upper half part being left with the first mold half, the lower half part being left with the second mold half;
moving the second mold half or rotating the second mold half 180 degrees to make the lower half part on the second mold half align with the upper half part on the first mold half;
injecting plastic material into the grooves which are respectively defined in two opposite outer sides of the combination of the upper half part with the lower half part, thereby forming two connecting strips therein to connect the upper half part with the lower half part; and
having the mold cooled, opening the mold and having the hollow product pushed out, thereby obtaining the hollow product.

2. The process as claimed in claim 1, wherein a total thickness of the upper half part, the lower half part and a corresponding connecting strip in combination of the upper half part with the lower half part from inside to outside the hollow product is 2-6 mm.

3. The process as claimed in claim 1, wherein each of the connecting strips is a strip which has a lathing structure.

4. A mold used for a process of injection molding of a hollow product having an irregular shape with plastic material instead of metal material of claim 1, said mold comprising;
a first mold half and a second mold half,
two first mold cavities being defined in the first mold half,
two second mold cores being formed on the first mold half,
two first mold cores being formed on the second mold half,
two second mold cavities being defined in the second mold half,
the first mold cavities of the first mold half being combined with the first mold cores of the second mold half to define a first chamber therebetween supplied for the upper half part of the hollow product, and
the second mold cavities of the first mold half being combined with the first mold cores of the second mold half to define a second chamber therebetween supplied for the lower half part of the hollow product.

5. A mold used for a process of injection molding of a hollow product having an irregular shape with plastic material instead of metal material of claim 2, said mold comprising;
a first mold half and a second mold half,
two first mold cavities being defined in the first mold half,
two second mold cores being formed on the first mold half,
two first mold cores being formed on the second mold half,
two second mold cavities being defined in the second mold half,
the first mold cavities of the first mold half being combined with the first mold cores of the second mold half to define a first chamber therebetween supplied for the upper half part of the hollow product, and
the second mold cavities of the first mold half being combined with the first mold cores of the second mold half to define a second chamber therebetween supplied for the lower half part of the hollow product.

6. A mold used for a process of injection molding of a hollow product having an irregular shape with plastic material instead of metal material of claim 3, said mold comprising;
a first mold half and a second mold half,
two first mold cavities being defined in the first mold half,
two second mold cores being formed on the first mold half,
two first mold cores being formed on the second mold half,
two second mold cavities being defined in the second mold half,
the first mold cavities of the first mold half being combined with the first mold cores of the second mold half to define a first chamber therebetween supplied for the upper half part of the hollow product, and
the second mold cavities of the first mold half being combined with the first mold cores of the second mold half to define a second chamber therebetween supplied for the lower half part of the hollow product.
